(19) United States
(12) Patent Application Publication
(10) Pub. No.: US 2013/0141331 A1
(43) Pub. Date: Jun. 6, 2013

(54) METHOD FOR PERFORMING WIRELESS DISPLAY CONTROL, AND ASSOCIATED APPARATUS AND ASSOCIATED COMPUTER PROGRAM PRODUCT

(71) Applicant: HTC Corporation, Taoyuan County (TW)

(72) Inventors: Duan-Ruei Shiu, Taoyuan County (TW); Chia-Fu Wu, Taoyuan County (TW); Fu-Sheng Yu, Taoyuan County (TW); Wei-Chih Kuo, Taoyuan County (TW); Ming-Han Tsai, Taoyuan County (TW); Jing-Lung Wu, Taoyuan County (TW); Chia-Wei Chen, Taoyuan County (TW); Hsin-Ti Chueh, Taoyuan County (TW); Chien-Kuang Fan Chiang, Taoyuan County (TW); Vasilis Polley, Bellevue, WA (US); Huaiyuan Wang, Bellevue, WA (US); Lin-Hao Yang, Taoyuan County (TW); Wang-Lin Ling, Taoyuan County (TW)

(73) Assignee: HTC CORPORATION, Taoyuan County (TW)

(21) Appl. No.: 13/689,780

(22) Filed: Nov. 30, 2012

Related U.S. Application Data
(60) Provisional application No. 61/566,015, filed on Dec. 2, 2011.
(60) Provisional application No. 61/623,926, filed on Apr. 13, 2012.

(51) Int. Cl. G09G 5/00

(52) U.S. Cl. CPC G09G 5/003
USPC 345/158

(57) ABSTRACT

A method and apparatus for performing wireless display control and an associated computer program product are provided, where the method is applied to an electronic device. The method includes: detecting whether a wireless display control agent device corresponding to the electronic device exists, wherein the wireless display control agent device is utilized as an agent for the electronic device to perform wireless display control on a display device electrically connected to the wireless display control agent device; and when it is detected that the wireless display control agent device exists, providing a user with a user interface, allowing the user to utilize a specific operating gesture to start an automatic wireless configuration of the electronic device without performing any manual wireless configuration of the electronic device, wherein based upon the automatic wireless configuration, a wireless connection between the electronic device and the wireless display control agent device is automatically established.

### CROSS REFERENCE TO RELATED APPLICATIONS

This application claims the benefit of U.S. Provisional Application No. 61/566,015, which was filed on Dec. 2, 2011 and is entitled “Wireless display architecture and method”, and is included herein by reference. This application further claims the benefit of U.S. Provisional Application No. 61/623,926, which was filed on Apr. 13, 2012 and is entitled “MULTIMEDIA MIRRORING OF MOBILE DEVICE BY GESTURE CONTROL”, and is included herein by reference.

### BACKGROUND OF THE INVENTION

1. Field of the Invention

The present invention relates to display control over an external device of a portable electronic device, and more particularly, to a method for performing wireless display control, and to an associated apparatus and an associated computer program product.

2. Description of the Prior Art

A conventional portable electronic device implemented according to the related art, such as a multifunctional mobile phone equipped with personal digital assistant (PDA) functionalities or a PDA equipped with mobile phone functionalities, may have become an important part of everyday life since it is very helpful. In a situation where the conventional portable electronic device is utilized for showing something to those around the user, some problems may occur. For example, the size of a liquid crystal display (LCD) module within the conventional portable electronic device may be too small if the viewers are many. In another example, the viewing experience may be degraded due to the small size of the LCD module within the conventional portable electronic device. Thus, a novel method is required for providing display control over an external device of an electronic device.

### SUMMARY OF THE INVENTION

It is therefore an objective of the claimed invention to provide a method for performing wireless display control, and to provide an associated apparatus and an associated computer program product, in order to solve the above-mentioned problems.

According to at least one preferred embodiment, a method for performing wireless display control is provided, where the method is applied to an electronic device. The method comprises the steps of: detecting whether a wireless display control agent device corresponding to the electronic device exists, wherein the wireless display control agent device is utilized as an agent for the electronic device to perform wireless display control on a display device in a situation where the display device is electrically connected to the wireless display control agent device; and when it is detected that the wireless display control agent device exists, providing a user with a user interface, allowing the user to utilize a specific operating gesture to start an automatic wireless configuration of the electronic device without performing any manual wireless configuration of the electronic device, wherein based upon the automatic wireless configuration, a wireless connection between the electronic device and the wireless display control agent device is automatically established.

According to at least one preferred embodiment, an apparatus for performing wireless display control is also provided, where the apparatus comprises at least one portion of an electronic device. The apparatus comprises a wireless control circuit and a processing circuit. The wireless control circuit is arranged to perform wireless communication control for the electronic device. In addition, the processing circuit is arranged to detect, by utilizing the wireless control circuit, whether a wireless display control agent device corresponding to the electronic device exists, with the wireless display control agent device being utilized as an agent for the electronic device to perform wireless display control on a display device in a situation where the display device is electrically connected to the wireless display control agent device. Additionally, when it is detected that the wireless display control agent device exists, the processing circuit provides a user with a user interface, allowing the user to utilize a specific operating gesture to start an automatic wireless configuration of the electronic device without performing any manual wireless configuration of the electronic device, wherein based upon the automatic wireless configuration, a wireless connection between the electronic device and the wireless display control agent device is automatically established.

According to at least one preferred embodiment, a computer program product is also provided, where the computer program product has program instructions for instructing a processor to perform a method comprising the steps of: detecting whether a wireless display control agent device corresponding to the electronic device exists, wherein the wireless display control agent device is utilized as an agent for the electronic device to perform wireless display control on a display device in a situation where the display device is electrically connected to the wireless display control agent device; and when it is detected that the wireless display control agent device exists, providing a user with a user interface, allowing the user to utilize a specific operating gesture to start an automatic wireless configuration of the electronic device without performing any manual wireless configuration of the electronic device, wherein based upon the automatic wireless configuration, a wireless connection between the electronic device and the wireless display control agent device is automatically established.

According to at least one preferred embodiment, a method for performing wireless display control is provided, where the method is applied to an electronic device. The method comprises the steps of: detecting whether a wireless display control agent device corresponding to the electronic device exists, wherein the wireless display control agent device is utilized as an agent for the electronic device to perform wireless display control on a display device in a situation where the display device is electrically connected to the wireless display control agent device; when it is detected that the wireless display control agent device exists, starting an automatic wireless configuration of the electronic device without performing any manual wireless configuration of the electronic device, wherein based upon the automatic wireless configuration, a wireless connection between the electronic device and the wireless display control agent device is automatically established; and providing a user with a user interface, allowing the user to utilize a specific operating gesture to display a portion or all of screen content of the electronic device on the display device via the wireless display control agent device.

It is an advantage of the present invention that the aforementioned method, the aforementioned apparatus, and the aforementioned computer program product allow the user of the electronic device to utilize the display device as an enlarged and extended screen for the electronic device. In addition, the aforementioned method, the aforementioned apparatus, and the aforementioned computer program product allow the user of the electronic device to control the display device with ease. Additionally, the related art problems (e.g. the problem of the small size of the liquid crystal display (LCD) module within the conventional portable electronic device, and the problem of the degraded viewing experience) can be prevented.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing wireless display control according to an example.

FIG. 2 illustrates a wireless display control scheme involved with the apparatus shown in FIG. 1 according to an example, where the apparatus of this example can be a mobile device, and a wireless display control agent device and a display device are also illustrated for better comprehension.

FIG. 3 illustrates a flowchart of a method for performing wireless display control according to an example.

FIGS. 4-7 illustrate some connection topologies of multiple wireless devices involved with the method shown in FIG. 3 according to respective examples, where the wireless devices may comprise the electronic device under consideration and the wireless display control agent device shown in FIG. 2.

FIGS. 8-20 illustrate some wireless display control schemes involved with the method shown in FIG. 3 according to respective examples.

FIG. 21 illustrates some implementation details of the mobile device shown in FIG. 2 according to an example.

FIG. 22 illustrates a schematic diagram of a user interface module for a touch event in the mobile device shown in FIG. 21 according to an example.

FIG. 23 illustrates a schematic diagram of the wireless display control agent device shown in FIG. 2 according to an example.

FIG. 24 illustrates a diagram of viewing a photo on the mobile device according to an example.

### DETAILED DESCRIPTION

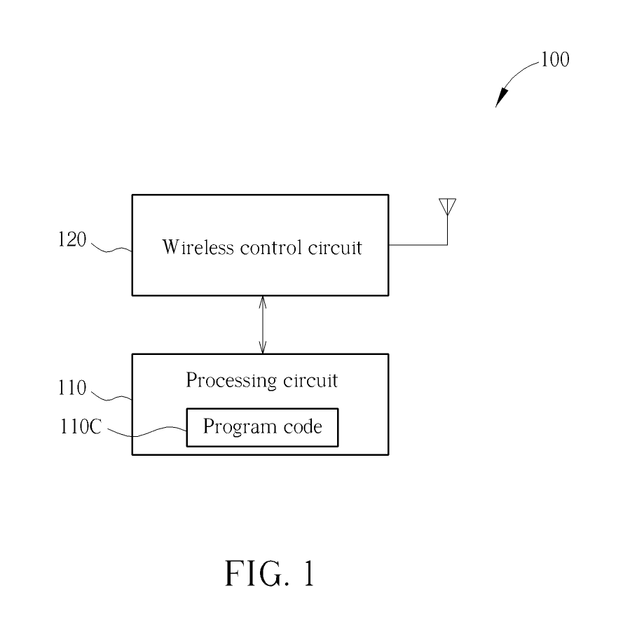

FIG. 1 is a diagram of an apparatus 100 for performing wireless display control, where the apparatus 100 may comprise at least one portion (e.g. a portion or all) of an electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. Examples of the electronic device may include, but not limited to, a mobile phone (e.g. a multifunctional mobile phone or smart phone), a mobile computer (e.g. tablet computer), a personal digital assistant (PDA), and a personal computer such as a laptop computer or desktop computer.

As shown in FIG. 1, the apparatus 100 comprises a processing circuit 110 and a wireless control circuit 120, which is typically coupled to an antenna such as that shown in FIG. 1, where the processing circuit 110 is arranged to control operations of the electronic device, and the wireless control circuit 120 is arranged to perform wireless communication control for the electronic device. Please note that the processing circuit 110 can be selectively implemented with the mixed scheme utilizing software (or firmware) module running on hardware circuit(s), or implemented with the pure hardware scheme. For example, the processing circuit 110 may comprise a processor and associated hardware circuits implemented by using at least one printed circuit board (PCB) on which the processor can be installed, and the aforementioned associated hardware circuit may comprise at least one memory (not shown) such as at least one random access memory (RAM) and/or at least one non-volatile memory (e.g. an electrically erasable programmable read only memory (EEPROM) or a Flash memory), where at least one program code 110C (e.g. one or more sets of program codes) may be stored in the aforementioned storage unit in advance and retrieved by the processing circuit 110 (more particularly, the processor mentioned above), for running on the processing circuit 110 as illustrated in FIG. 1. This is for illustrative purposes only, and is not meant to be a limitation. In another example, the processing circuit 110 may be implemented as pure hardware circuit(s), where the aforementioned program code 110C is imbedded therein.

In addition, the processing circuit 110 is further arranged to detect, by utilizing the wireless control circuit 120, whether a wireless display control agent device (not shown in FIG. 1) corresponding to the electronic device exists, with the wireless display control agent device being utilized as an agent for the electronic device to perform wireless display control on a display device (not shown in FIG. 1) in a situation where the display device is electrically connected to the wireless display control agent device. When it is detected that the wireless display control agent device exists, the processing circuit 110 typically provides a user with a user interface, allowing the user to utilize a specific operating gesture (e.g. a specific three-finger gesture) to start an automatic wireless configuration of the electronic device without performing any manual wireless configuration of the electronic device. For instance, the specific three-finger gesture can be that the user moves three fingers toward a certain direction and over a certain distance on a touch screen of the electronic device. In practice, based upon the automatic wireless configuration mentioned above, a wireless connection between the aforementioned electronic device and the aforementioned wireless display control agent device can be automatically established.

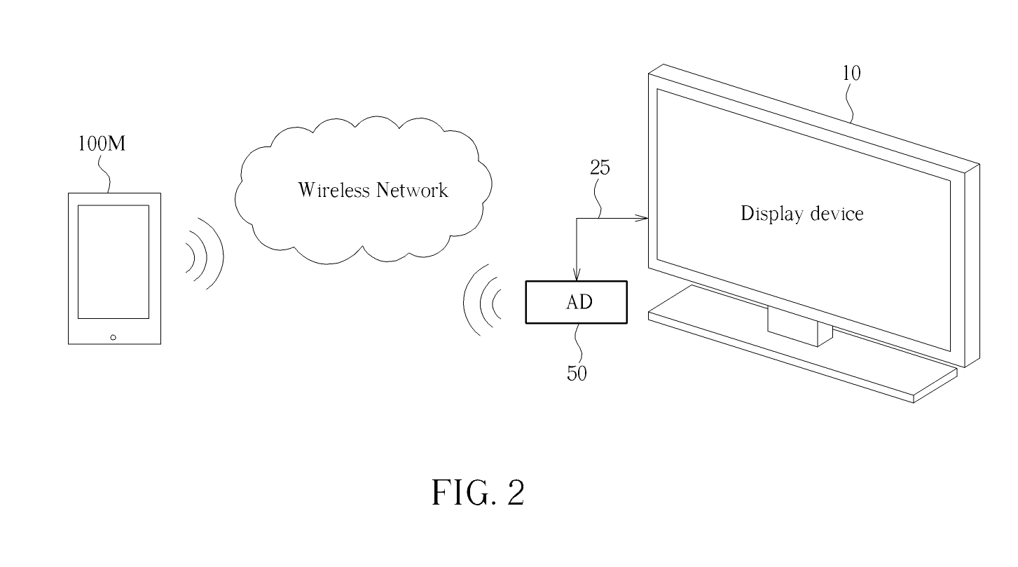

FIG. 2 illustrates a wireless display control scheme involved with the apparatus 100 shown in FIG. 1 according to an example, where the apparatus 100 of this example can be a mobile device 100M (e.g. a mobile phone, a tablet, etc.), and a wireless display control agent device 50 (labeled “AD”, which stands for “agent device”, for brevity) and a display device 10 such as a multifunctional television (TV) or a digital TV are also illustrated for better comprehension. The wireless display control agent device 50 shown in FIG. 2 can be taken as an example of the aforementioned wireless display control agent device, and the display device 10 shown in FIG. 2 can be taken as an example of the aforementioned display device, where the wireless display control agent device 50 may comprise a connection port for being electrically connected to the display device 10. For example, in a situation where the connection port mentioned above is a High-Definition Multimedia Interface (HDMI) port, the connection 25 between the wireless display control agent device 50 and the display device 10 may be implemented with an HDMI cable. In another example, in a situation where the connection port mentioned above is a Universal Serial Bus (USB) port, the connection 25 between the wireless display control agent device 50 and the display device 10 may be implemented with a USB cable, or may represent a direct connection between the USB port of the wireless display control agent device 50 and an associated USB port of the display device 10. In particular, the wireless display control agent device 50 can be a dongle (e.g. a multimedia dongle) having a wireless display control functions for supporting the wireless display control of the apparatus 100, and therefore can be referred to as the wireless display control dongle.

Regarding the wireless network shown in FIG. 2, a plurality of wireless devices may be involved, where these wireless devices may comprise the electronic device under consideration (which can be the apparatus 100 here) and the wireless display control agent device 50. For example, the wireless connection mentioned above may comprise a direct wireless connection between the apparatus 100 (more particularly, the mobile device 100M) and the wireless display control agent device 50, where the number of wireless devices regarding this wireless network can be greater than or equal to two. In particular, the wireless connection mentioned above can be a Wireless-Fidelity (Wi-Fi) connection. In another example, the wireless connection mentioned above may comprise an indirect wireless connection that passes through a router (not shown in FIG. 2), where the number of wireless devices regarding this wireless network can be greater than two, and the plurality of wireless devices may further comprise the router. In particular, the wireless connection mentioned above can be a Wi-Fi connection that passes through the router.

Based on the wireless display control scheme mentioned above, the user can easily trigger the automatic wireless configuration mentioned above with the aforementioned specific operating gesture (e.g. by merely pressing a button of the mobile device 100M, or by merely touching a virtual button on a touch screen of the mobile device 100M), and then the apparatus 100 (more particularly, the mobile device 100M) executing the program code 110C can automatically establish the wireless connection mentioned above.

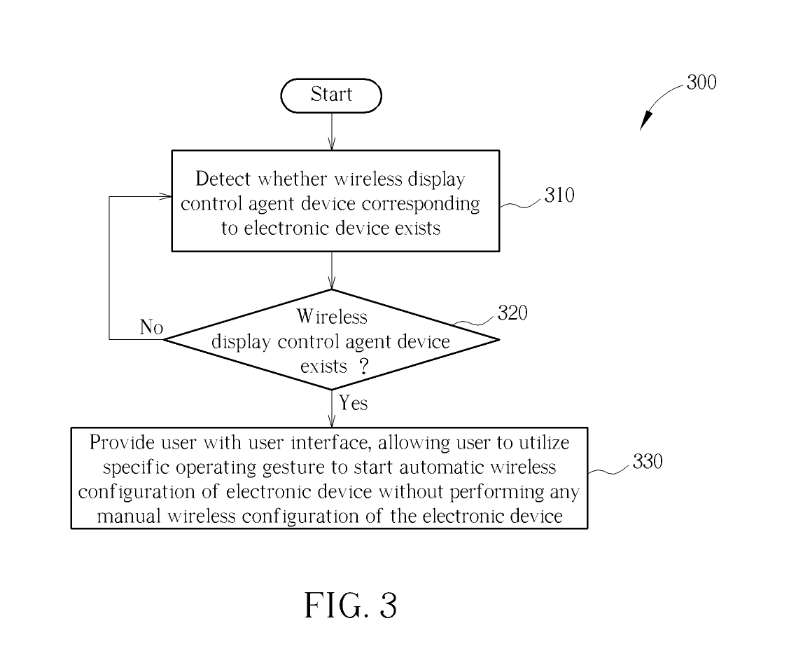

FIG. 3 illustrates a flowchart of a method 300 for performing wireless display control according to an example. The method shown in FIG. 3 can be applied to the apparatus 100 shown in FIG. 1 (more particularly, the mobile device 100M of the example shown in FIG. 2), and can be applied to the processing circuit 110 thereof (more particularly, the processing circuit 110 executing the program code 110C mentioned above). For example, the program code 110C may be provided through a computer program product having program instructions for instructing a processor such as that mentioned above to perform the method 300 shown in FIG. 3, where the computer program product may be implemented as a non-transitory computer-readable medium (e.g. a floppy disk or a compact disc-read only memory (CD-ROM)) storing the program instructions or an equivalent version thereof, such as a software package for being installed. The method is described as follows.

In Step 310, the processing circuit 110 detects whether the wireless display control agent device 50 corresponding to the electronic device mentioned above exists, with the wireless display control agent device 50 being utilized as an agent for the electronic device to perform wireless display control on the display device 10 in a situation where the display device 10 is electrically connected to the wireless display control agent device 50. More particularly, the processing circuit 110 automatically scans for the wireless display control agent device 50 to detect whether the wireless display control agent device 50 exists, where the wireless display control agent device 50 is equipped with an access point (AP) function that is activated by default for the purpose of being scanned by the electronic device mentioned above.

In Step 320, the processing circuit 110 checks whether the wireless display control agent device 50 exists. When it is detected that the wireless display control agent device exists, Step 330 is entered; otherwise, Step 310 is re-entered. For example, in a situation where the processing circuit 110 automatically scans for the wireless display control agent device 50, the processing circuit 110 may obtain a list indicating any wireless device available, so the processing circuit 110 may determine whether a wireless device in the latest version of this list is the wireless display control agent device 50. Thus, when it is detected that a wireless device in the latest version of this list is the wireless display control agent device 50, which means the wireless display control agent device exists, Step 330 is entered. In practice, in a situation where the working flow stays in the loop formed with Step 310 and Step 320 (e.g., for one or more seconds, or one or more minutes), the processing circuit 110 may repeatedly or periodically scan for the wireless display control agent device 50.

In Step 330, the processing circuit 110 provides the user with a user interface such as that mentioned above, allowing the user to utilize the specific operating gesture to start the aforementioned automatic wireless configuration of the electronic device without performing any manual wireless configuration of the electronic device. More particularly, when it is detected that the user inputs the specific operating gesture into the electronic device, the processing circuit 110 controls the electronic device to start the automatic wireless configuration. Based upon the automatic wireless configuration, the aforementioned wireless connection between the electronic device and the wireless display control agent device 50 is automatically established.

More particularly, during the automatic wireless configuration, the processing circuit 110 may select one of a plurality of predetermined connection topologies of the plurality of wireless devices according to a predetermined priority, with the plurality of wireless devices comprising the electronic device mentioned above and the wireless display control agent device 50. For example, the predetermined priority may correspond to at least one of power and throughput associated with the predetermined connection topologies (e.g., the predetermined priority may correspond to power, and/or the predetermined priority may correspond to throughput). In practice, the processing circuit 110 can dynamically switches between the predetermined connection topologies when needed.

For example, the specific operating gesture mentioned above may be the only operating gesture that is utilized for starting the aforementioned automatic wireless configuration. Thus, when it is detected that the wireless display control agent device 50 exists, the processing circuit 110 provides the user with the user interface, allowing the user to merely utilize the specific operating gesture to start the automatic wireless configuration of the electronic device without performing any manual wireless configuration of the electronic device.

In another example, when it is detected that the wireless display control agent device 50 exists, the processing circuit 110 can control the electronic device to start the aforementioned automatic wireless configuration directly without any user input, including establishing the wireless connection between the electronic device and the wireless display control agent device 50, selecting one of the available predetermined connection topologies, etc. Then, the user can utilize the specific operating gesture (e.g. a specific three-finger gesture) via the user interface to display a portion or all of the screen content of the electronic device on the display device 10 via the wireless display control agent device 50.

In another example, when it is detected that the wireless display control agent device 50 exists, the processing circuit 110 may generate a notification indicating that the wireless display control agent device 50 is found. For instance, the processing circuit 110 may control a display module of the electronic device (e.g., a touch screen of the mobile device 100M) to display this notification.

In another example, the processing circuit 110 may control the electronic device to output a command to the wireless display control agent device 50 through the wireless connection mentioned above, in order to turn on or turn off the display device 10 by utilizing the wireless display control agent device 50.

In another example, the processing circuit 110 may control a display module of the electronic device (e.g., the aforementioned touch screen of the mobile device 100M) and the display device 10 to display different screen contents, respectively, where the screen content of the display device 10 is received through the wireless display control agent device 50.

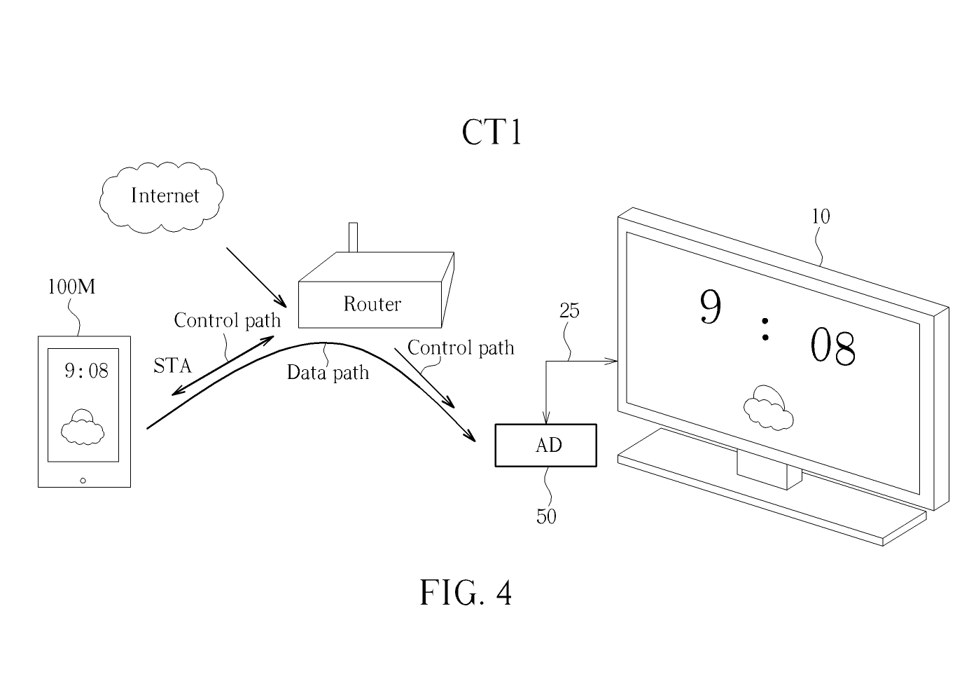

FIGS. 4-7 illustrate some connection topologies of multiple wireless devices involved with the method 300 shown in FIG. 3 according to respective examples, where the wireless devices may comprise the electronic device under consideration and the wireless display control agent device 50 shown in FIG. 2. For example, during the automatic wireless configuration, the processing circuit 110 may select one of the predetermined connection topologies {CT1, CT2, CT3, CT4} of the plurality of wireless devices, such as those shown in FIGS. 4-7, according to the aforementioned predetermined priority for the connection setup of the wireless connection mentioned above.

By utilizing the leverage regarding concurrent access point (AP) and station (STA) connection in both of the wireless display control agent device 50 (more particularly, the aforementioned dongle) and the electronic device (more particularly, the mobile device 100M), the aforementioned Wi-Fi connection can be established in any case. Typically, the wireless display control agent device 50 may play the roles of AP and STA at the same time. In particular, the electronic device (more particularly, the mobile device 100M) may play the roles of AP and STA at the same time.

Please note that in FIGS. 4-7, some data paths and some control paths are illustrated, where the data paths stand for the paths for transmitting data, and the control paths stand for the paths for transmitting control information such as some commands. In addition, the roles of AP or STA may be labeled on one side of a path (e.g. one of the data paths, or one of the control paths), which means the wireless device corresponding to this side (e.g. the mobile device 100M, or the wireless display control agent device 50) plays the roles of AP or STA that is labeled on this side of this path under consideration.

Regarding the connection topology CT1 shown in FIG. 4, a data path starts from the mobile device 100M, passes through the router, and is directed to the wireless display control agent device 50. In addition, there is a control path between the mobile device 100M and the router, and there is a control path that starts from the router and is directed to the wireless display control agent device 50. Additionally, the router may access the Internet. For example, as a result of utilizing the connection topology CT1 shown in FIG. 4, the display contents of the display device 10 may be controlled to be the same as that of the mobile device 100M (e.g. the time “9:08” displayed on the display device 10 may be the same as that displayed on the display module (or the touch screen) of the mobile device 100M).

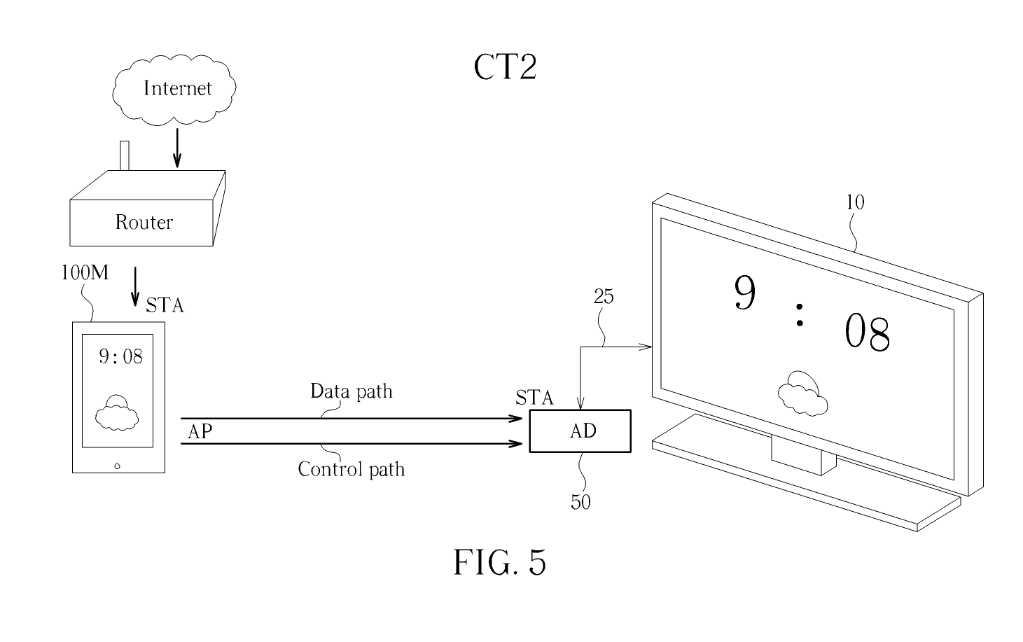

Regarding the connection topology CT2 shown in FIG. 5, a data path starts from the mobile device 100M and is directed to the wireless display control agent device 50. In addition, there is a control path that starts from the mobile device 100M and is directed to the wireless display control agent device 50. Additionally, the mobile device 100M may access the Internet through the router. For example, as a result of utilizing the connection topology CT2 shown in FIG. 5, the display contents of the display device 10 may be controlled to be the same as that of the mobile device 100M (e.g. the time “9:08” displayed on the display device 10 may be the same as that displayed on the display module (or the touch screen) of the mobile device 100M).

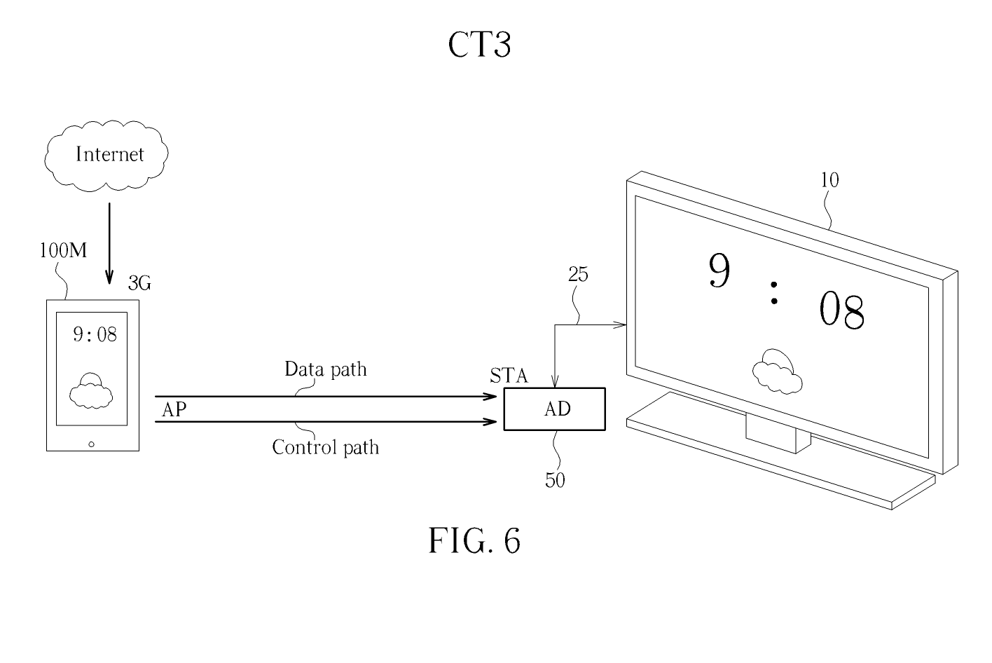

Regarding the connection topology CT3 shown in FIG. 6, a data path starts from the mobile device 100M and is directed to the wireless display control agent device 50. In addition, there is a control path that starts from the mobile device 100M and is directed to the wireless display control agent device 50. Additionally, the mobile device 100M may access the Internet through the 3^{rd} Generation (3G) wireless connection (labeled “3G” in FIG. 6, for brevity). For example, as a result of utilizing the connection topology CT3 shown in FIG. 6, the display contents of the display device 10 may be controlled to be the same as that of the mobile device 100M (e.g. the time “9:08” displayed on the display device 10 may be the same as that displayed on the display module (or the touch screen) of the mobile device 100M).

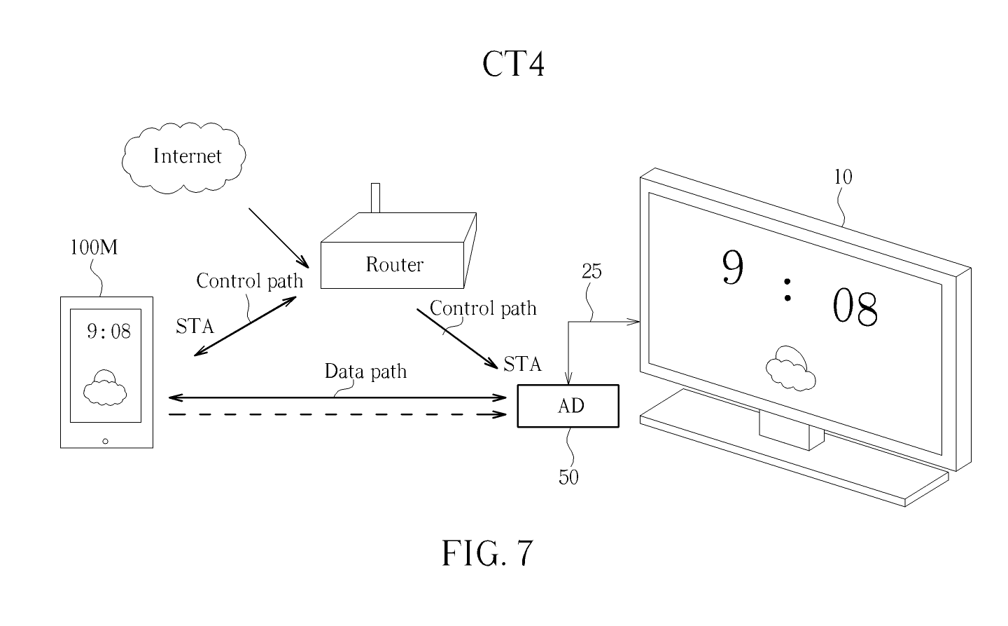

Regarding the connection topology CT4 shown in FIG. 7, there is a data path between the mobile device 100M and the wireless display control agent device 50. In addition, there is a control path between the mobile device 100M and the router, and there is a control path that starts from the router and is directed to the wireless display control agent device 50. Additionally, the router may access the Internet. For example, as a result of utilizing the connection topology CT4 shown in FIG. 7, the display contents of the display device 10 may be controlled to be the same as that of the mobile device 100M (e.g. the time “9:08” displayed on the display device 10 may be the same as that displayed on the display module (or the touch screen) of the mobile device 100M). In practice, the data path between the mobile device 100M and the wireless display control agent device 50 may be a bidirectional data path. This is for illustrative purposes only, and is not meant to be a limitation. In another example, the data path between the mobile device 100M and the wireless display control agent device 50 may be a data path that starts from the mobile device 100M and is directed to the wireless display control agent device 50.

Please note that the processing circuit 110 may select one of the connection topologies, and more particularly, may dynamically switch between the predetermined connection topologies when needed. For example, the selection may depend on the situation encountered. As mentioned above, the predetermined priority may correspond to at least one of power and throughput (e.g., the predetermined priority may correspond to power, and/or the predetermined priority may correspond to throughput). That is, the processing circuit 110 may select one of the connection topologies CT1, CT2, CT3, and CT4 according to the predetermined priority, which may correspond to power and/or throughput.

For example, based upon predetermined priority corresponding to power, the priority can be:

CT4=CT1>CT2>CT3; or

CT4=CT1>CT2≈CT3.

The former of the above priority relationships between the connection topologies CT1, CT2, CT3, and CT4 (i.e. the priority relationship “CT4=CT1>CT2>CT3”) means that the connection topologies CT4 or CT1 may be selected first if any of them is available, and that the connection topology CT2 may be selected first if the connection topologies CT4 and CT1 are not available, and that the connection topology CT3 may be selected if the connection topologies CT1, CT2, and CT4 are not available. In addition, the latter of the above priority relationships between the connection topologies CT1, CT2, CT3, and CT4 (i.e. the priority relationship “CT4=CT1>CT2≈CT3”) means that the connection topologies CT4 or CT1 may be selected first if any of them is available, and that the connection topologies CT2 or CT3 may be selected if the connection topologies CT4 and CT1 are not available.

In another example, based upon predetermined priority corresponding to throughput, the priority can be:

CT4>CT2>CT1>CT3.

The above priority relationship between the connection topologies CT1, CT2, CT3, and CT4 (i.e. the priority relationship “CT4>CT2>CT1>CT3”) means that the connection topology CT4 may be selected first if it is available, and that the connection topology CT2 may be selected first if the connection topology CT4 is not available, and that the connection topology CT1 may be selected first if the connection topologies CT4 and CT2 are not available, and that the connection topology CT3 may be selected if the connection topologies CT1, CT2, and CT4 are not available.

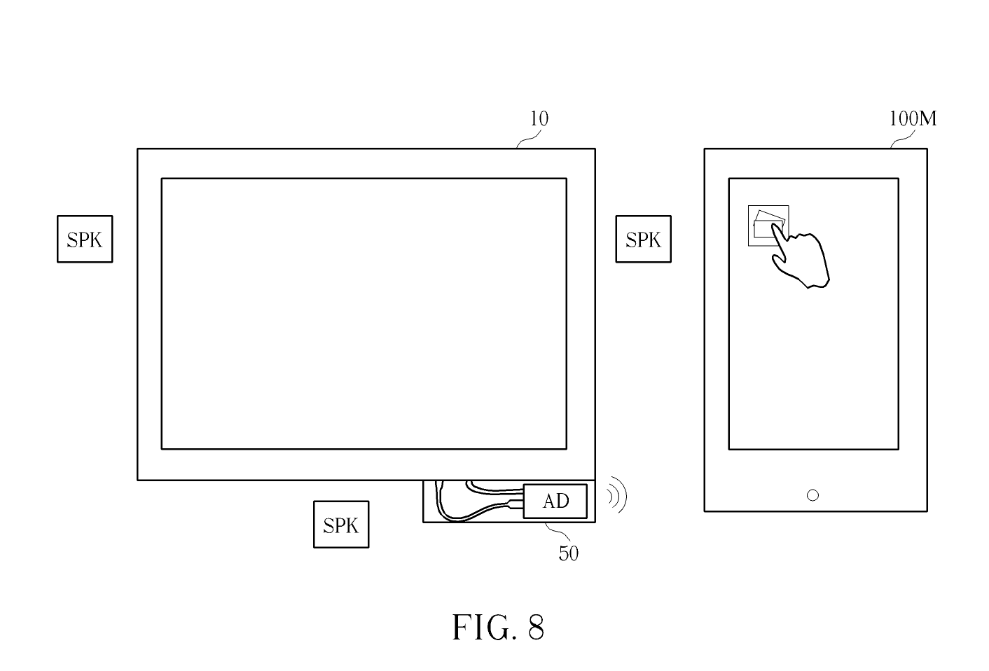

FIGS. 8-20 illustrate some wireless display control schemes involved with the method 300 shown in FIG. 3 according to respective examples. The notation “SPK” shown in a portion of FIGS. 8-20 stands for “speaker”, which means the display device 10 in the associated wireless display control schemes may be equipped with the speakers as illustrated. In addition, as shown in FIGS. 8-20, the wireless display control agent device 50 may be equipped with multiple cables to control the display device 10. For example, the cables may comprise a power cable such as a USB cable for obtaining power from the display device 10, and may further comprise an HDMI cable for outputting display data and audio data to the display device 10. In another example, the cables may comprise a power cable such as a USB cable for obtaining power from the display device 10, and may further comprise another USB cable for outputting display data and audio data to the display device 10. In another example, the cables may comprise a power cable such as a USB cable for obtaining power from the display device 10, and may further comprise a set of audio/video (A/V) cables for outputting A/V signals to the display device 10, respectively.

The wireless display control scheme shown in FIGS. 8-10 can be described with the following steps:

Step S11: The user opens an application such as the Media Link application on the mobile device 100M, as shown in FIG. 8, where the Media Link application can be taken as an example of the program code 110C. Thus, under control of the Media Link application, the processing circuit 110 may operate according to the method 300 shown in FIG. 3.

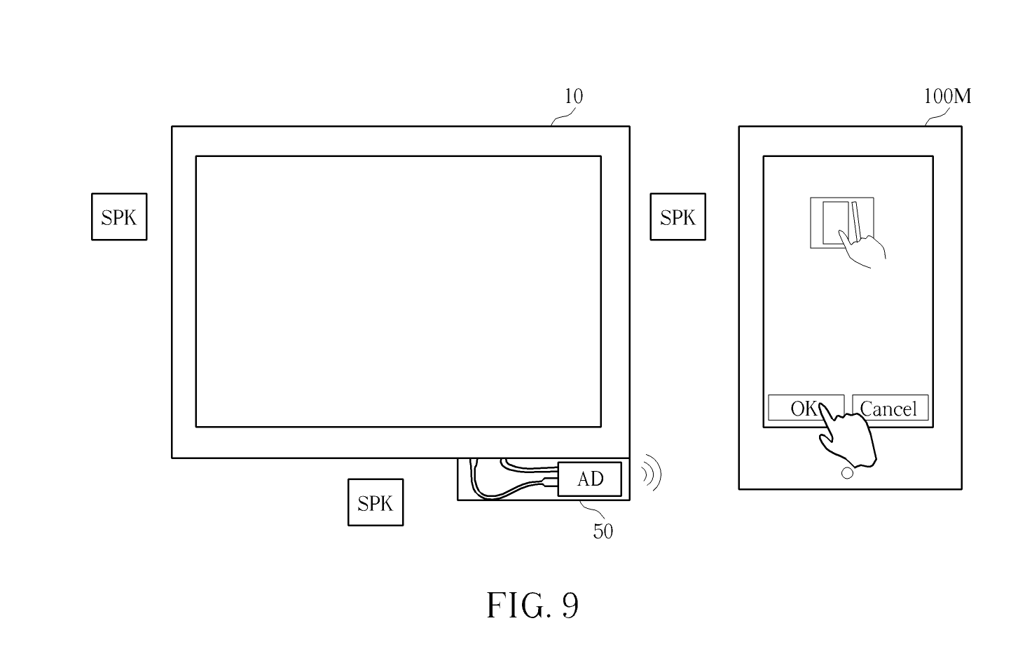

Step S12: The user clicks (or touches) the virtual button “OK” on the touch screen of the mobile device 100M, as shown in FIG. 9. Thus, the user can easily trigger the automatic wireless configuration mentioned above with the aforementioned specific operating gesture, by merely touching the virtual button “OK”. The virtual button “Cancel” shown in FIG. 9 allows the user to cancel triggering the automatic wireless configuration when needed, in a situation where the user clicks (or touches) the virtual button “Cancel”.

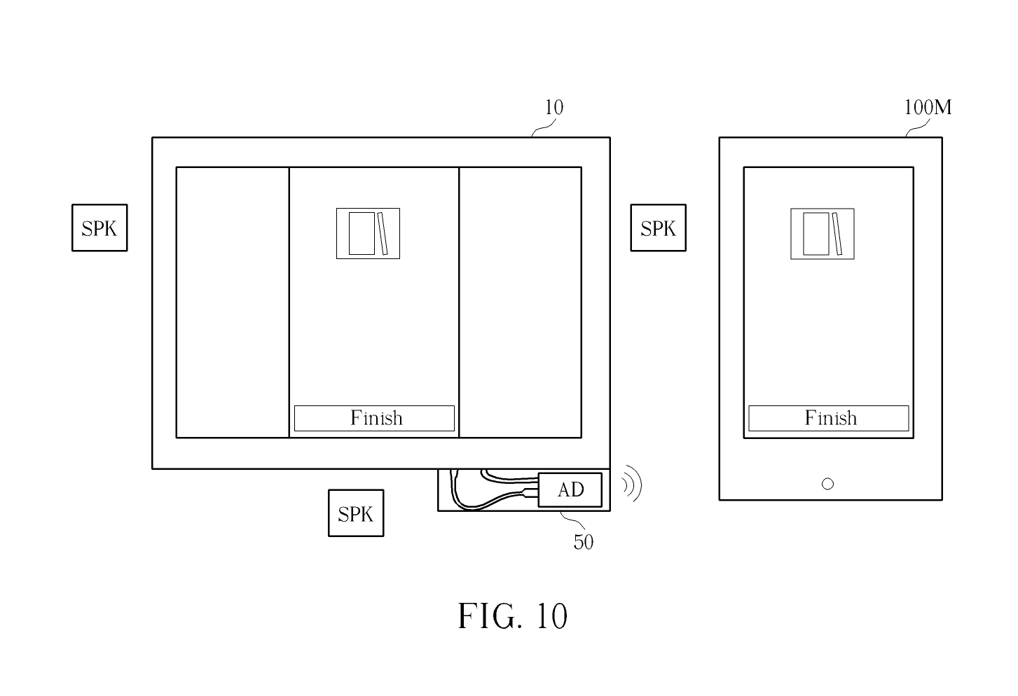

Step S13: As a result of triggering the automatic wireless configuration, the wireless connection mentioned above is established. For example, the display contents that are currently displayed on the touch screen of the mobile device 100M are automatically displayed on the display device 10 with the aid of the wireless display control agent device 50, as shown in FIG. 10.

Regarding the associated connection procedure, for example, while the user clicks (or touches) the virtual button “OK”, the mobile device 100M comprising the processing circuit 110 executing the program code 110C (e.g. the application disclosed in Step S11) and the wireless display control agent device 50 will first try to find each other in an AP (e.g. the router disclosed above) known by both of them. If the above operation (i.e. the operation of trying to find each other in an AP) is not successful, the mobile device 100M will enable the mobile AP thereof, and the wireless display control agent device 50 will try to connect to the mobile AP of the mobile device 100M. As a result, both of them (i.e. the mobile device 100M and the wireless display control agent device 50) will be wirelessly connected in one of the connection topologies disclosed above, so the mobile device 100M and the wireless display control agent device 50 may continue the remaining handshaking for the streaming operations.

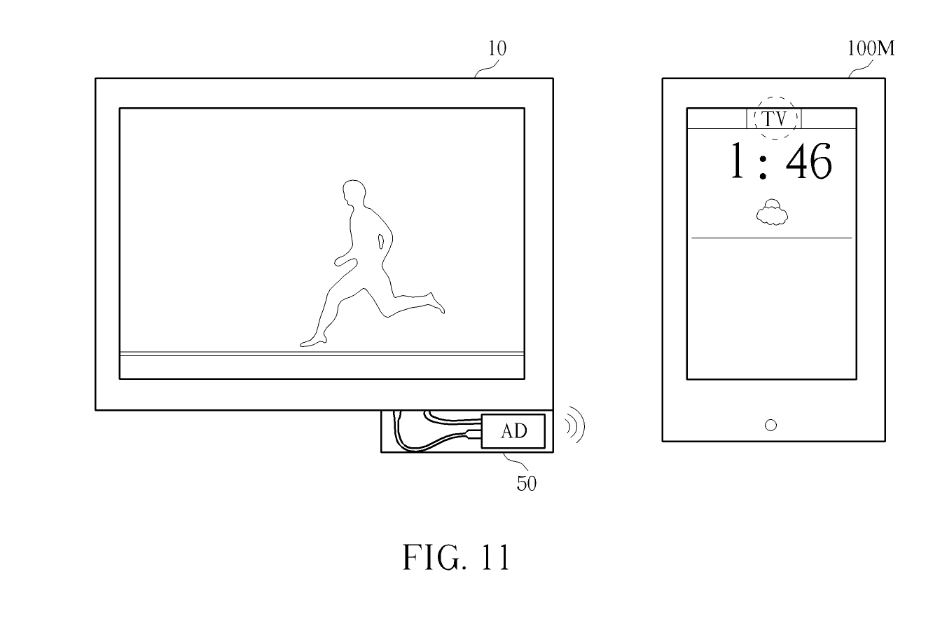

Some implementation details regarding the aforementioned notification (i.e. the notification indicating that the wireless display control agent device 50 is found) may be described with the wireless display control scheme shown in FIGS. 11-14 as follows.

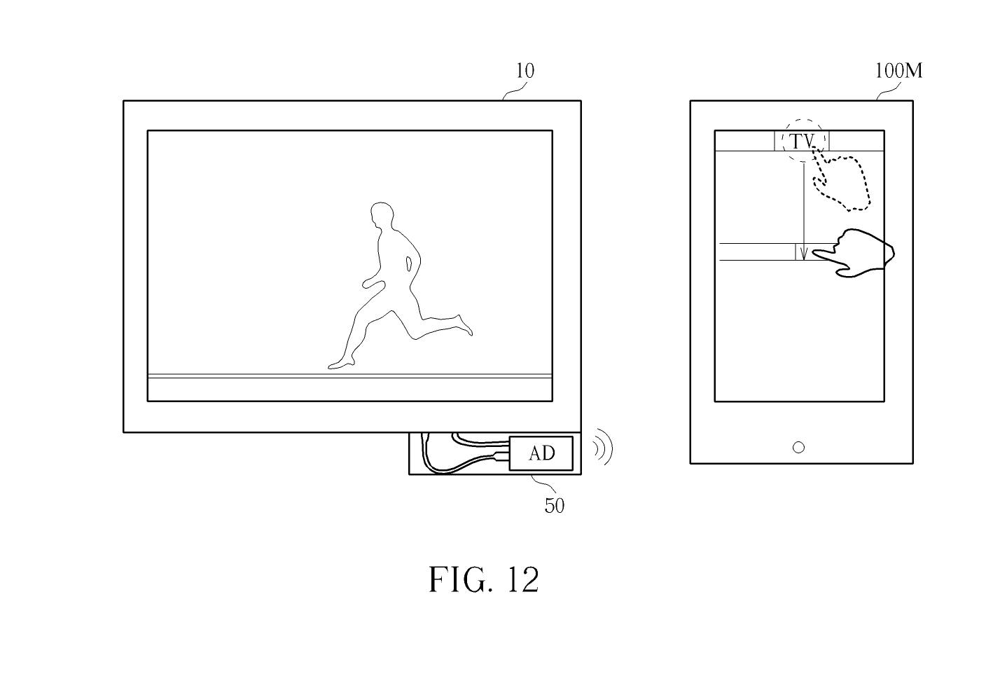

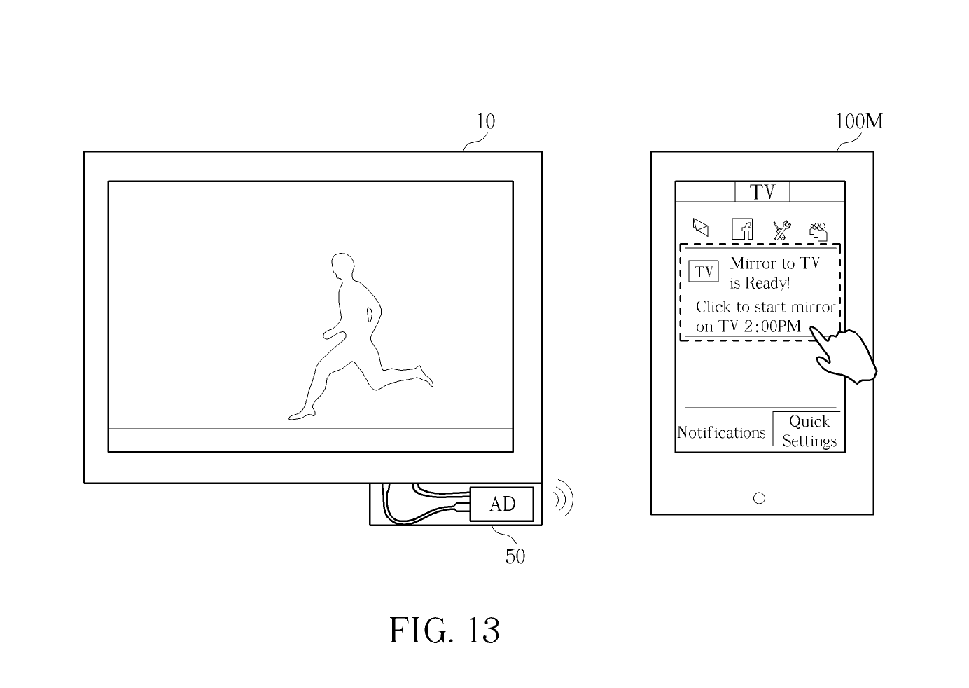

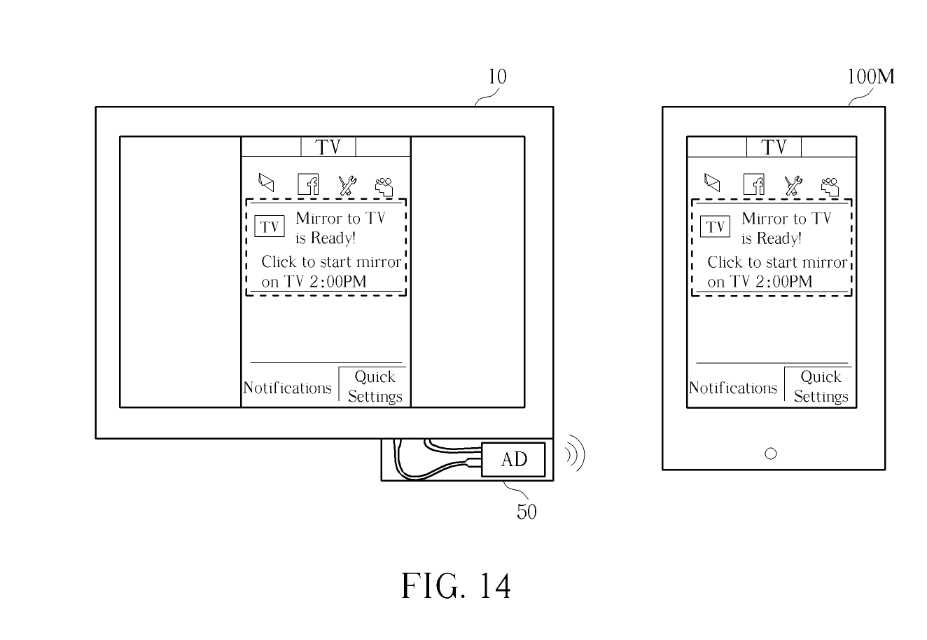

Please refer to FIG. 2 again. For example, the user may go home and walk into the living room where the display device 10 (which can be a TV in this example, such as the multifunctional TV or the digital TV disclosed above) is positioned. When the user goes into the Wi-Fi connection range (more particularly, the Wi-Fi connection network coverage of the wireless display control agent device 50, where the signal strength may be strong enough for establishing the wireless connection mentioned above), the mobile device 100M will output the aforementioned notification indicating that the wireless display control agent device 50 is found (e.g. notification labeled “TV” on the touch screen of the mobile device 100M shown in FIG. 11). The user may click (or touch) or drag the notification “TV” shown in FIG. 12 to trigger the automatic wireless configuration mentioned above, or the automatic wireless configuration may be directly triggered without any user input. After the wireless connection mentioned above is established, under control of the program code 110C, the mobile device 100M may display the bar having the message “Mirror to TV is Ready! Click to start mirror on TV” shown in FIG. 13, and the user may start the mirror display operation by touching the bar having the message “Mirror to TV is Ready! Click to start mirror on TV” shown in FIG. 13, in order to utilize the display device 10 typically having a larger display size than that of the mobile device 100M as shown in FIG. 14. In practice, the bar having the message “Mirror to TV is Ready! Click to start mirror on TV” can be an entry of the tab labeled “Notifications”, where the tab labeled “Quick Settings” may comprise some entries for perform some settings of the mobile device 100M, respectively.

In this example, the user may start the mirror display operation by touching the bar having the message “Mirror to TV is Ready! Click to start mirror on TV” shown in FIG. 13. This is for illustrative purposes only, and is not meant to be a limitation. In another example, the associated operation(s) regarding FIG. 13 can be omitted, where the message “Mirror to TV is Ready! Click to start mirror on TV” shown in FIG. 13 will not be displayed, and it is unnecessary for the user to touch the bar having the message “Mirror to TV is Ready! Click to start mirror on TV” shown in FIG. 13. That is, the user may merely click (or touch) or drag the notification “TV” shown in FIG. 12 to trigger the automatic wireless configuration mentioned above and then just wait for the mirroring results.

Regarding the associated procedure, for example, while the user brings the mobile device 100M into the aforementioned Wi-Fi connection range (more particularly, the Wi-Fi connection network coverage of the wireless display control agent device 50, where the signal strength may be strong enough for establishing the wireless connection mentioned above), the mobile device 100M may scan, search, probe, or listen to the Wi-Fi network in the environment and/or connect to the home access point such as the aforementioned router (e.g., by using any of the available connection topologies {CT1, CT2, CT3, CT4} disclosed above). Then, the mobile device 100M may detect that the wireless display control agent device 50 is within the connection range, and display the aforementioned notification on the touch screen of the mobile device 100M. While the user clicks (or touches) the notification, the application disclosed above may establish the wireless connection between the mobile device 100M and the wireless display control agent device 50, and then deliver the associated contents (more particularly, the display data and the audio data) to the wireless display control agent device 50 to process the associated contents and display on the display device 10. If, within the aforementioned list indicating any wireless device available, there are multiple dongles, the user may need to select one of them from the list to continue the streaming operation mentioned above.

In practice, for user's convenience, a wireless control function for turning on/off TV using the mobile device 100M may be provided. Please refer to FIG. 2. The user may turn on/off the display device 10 by pushing a soft button on the mobile device 100M (more particularly, a virtual button on the touch screen of the mobile device 100M). This is for illustrative purposes only, and is not meant to be a limitation. In another example, the user may turn on the display device 10 to transmit the display contents of the mobile device 100M toward the display device 10 by pushing a touch button or a physical button on the mobile device 100M.

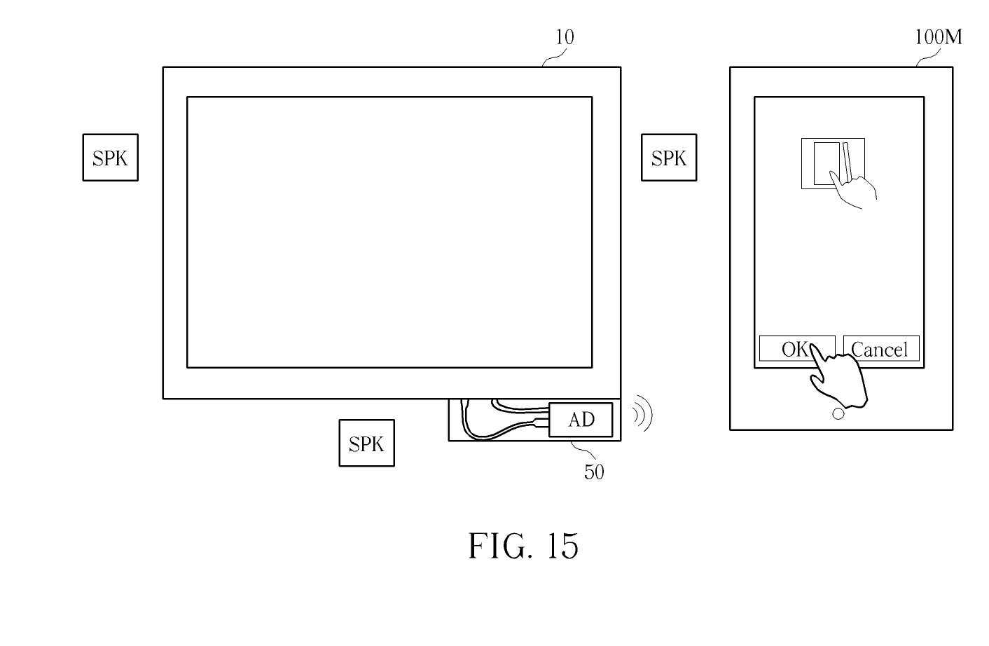

In the wireless display control scheme shown in FIGS. 15-18, the wireless control function for turning on/off TV using the mobile device 100M can be described with the following steps:

Step S21: In a situation where the display device 10 (e.g. the TV mentioned above) is turned off (e.g., in a TV power off state), the user clicks (or touches) a soft button on the mobile device 100M shown in FIG. 15, such as the virtual button labeled “OK” on the touch screen of the mobile device 100M.

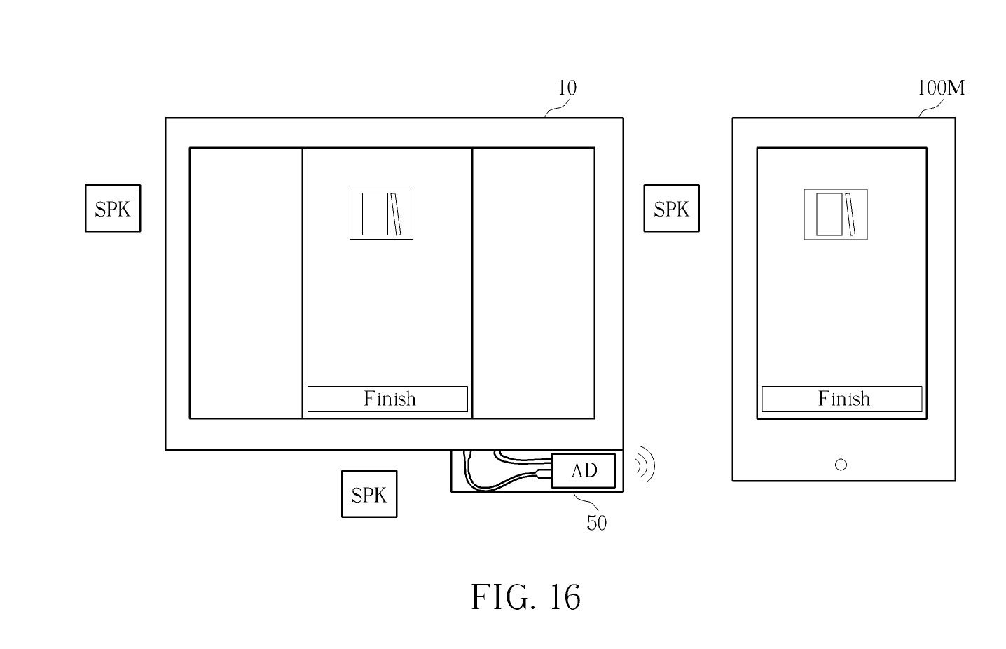

Step S22: The display device 10 is turned on (e.g., in a TV power on state) under control of the wireless display control agent device 50. As the wireless connection between the wireless display control agent device 50 and the mobile device 100M is established, the display contents that are currently displayed on the touch screen of the mobile device 100M are automatically displayed on the display device 10 with the aid of the wireless display control agent device 50, as shown in FIG. 16.

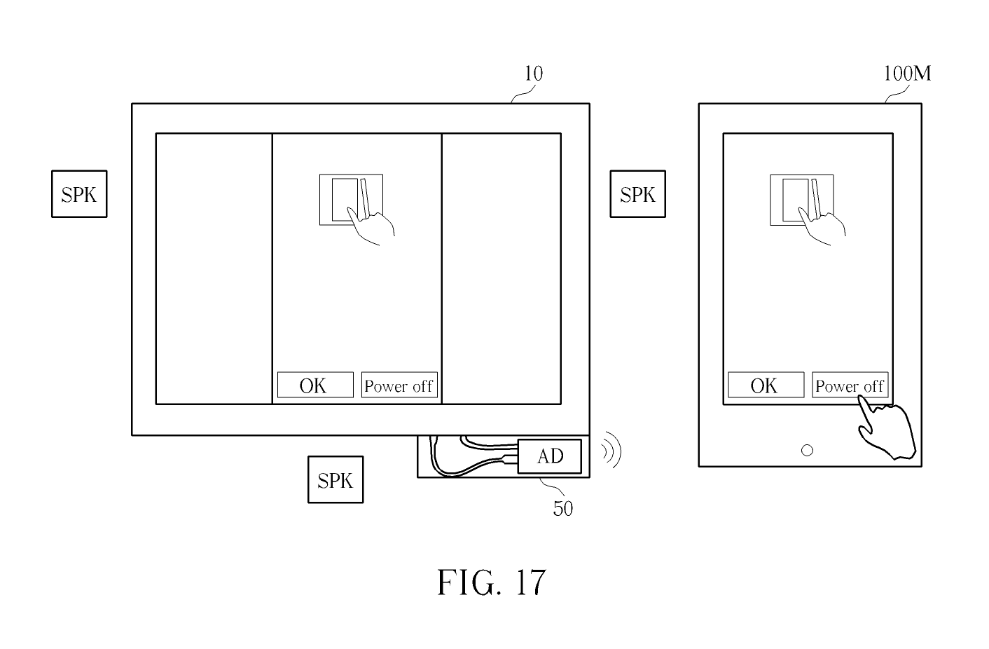

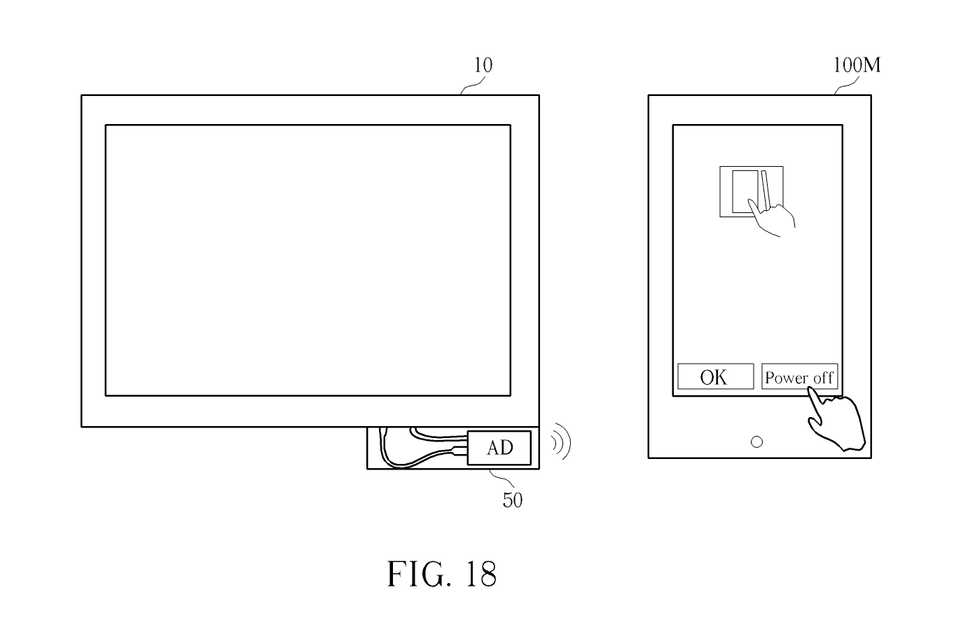

Step S23: The user clicks (or touches) a soft button on the mobile device 100M shown in FIG. 17, such as the virtual button labeled “Power off” on the touch screen of the mobile device 100M. As a result, the display device 10 is turned off under control of the wireless display control agent device 50 as shown in FIG. 18.

Regarding the associated procedure, for example, while the user clicks (or touches) the virtual button labeled “OK”, the application disclosed above may send a special information element of the Wi-Fi signal to the wireless display control agent device 50, and then the wireless display control agent device 50 will enter an active state. While the wireless display control agent device 50 enters the active state, it may send the power up signal via HDMI Consumer Electronic Control (CEC) control (e.g. a control module/circuit of HDMI CEC in the wireless display control agent device 50) to the display device 10. As a result, the display device 10 is in the power on state thereof The wireless display control agent device 50 may send the mirror display contents to the display device 10 and/or send Digital Living Network Alliance (DLNA) streaming contents for playback. While the user clicks (or touches) the virtual button labeled “Power off”, the wireless display control agent device 50 may send the power off signal via HDMI CEC control to the display device 10. As a result, the display device 10 is in the power off state thereof The wireless display control agent device 50 may enter the stand-by or power off state thereof while the display device 10 is turned off.

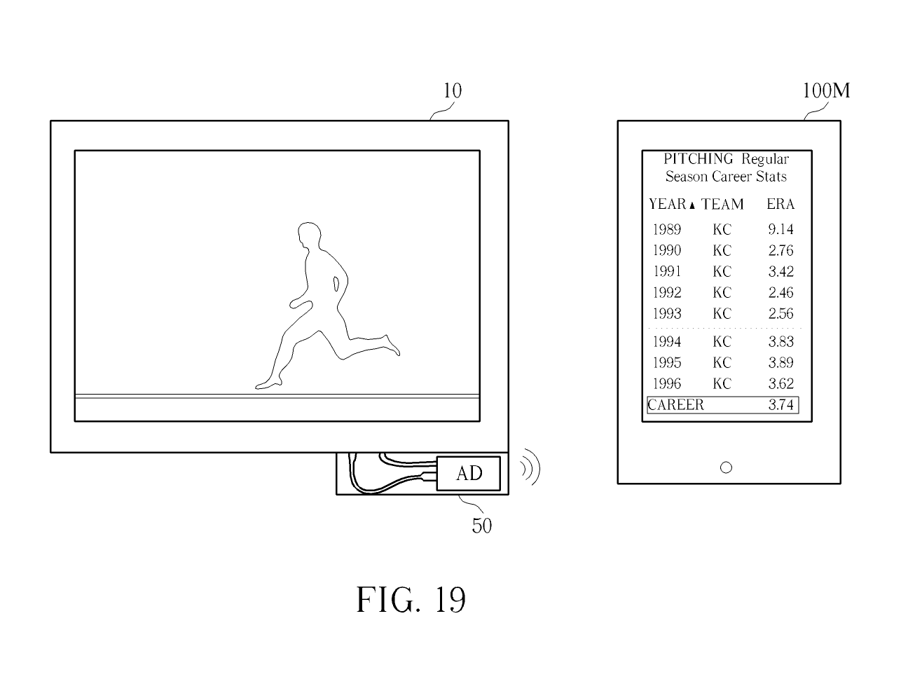

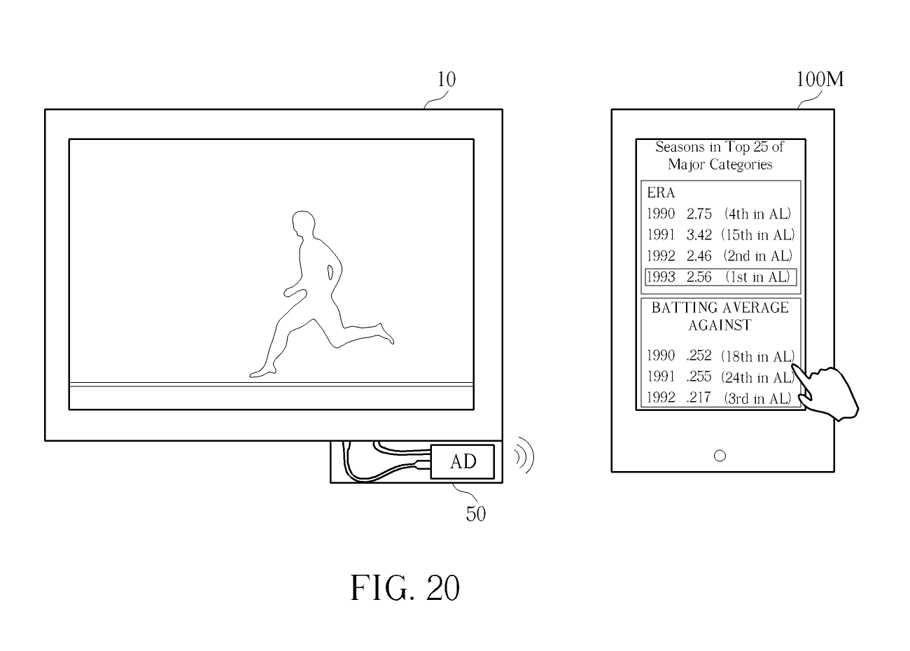

In the wireless display control scheme shown in FIGS. 19-20, a multiple-screen function for showing different screen contents on different screen devices may be provided. Please refer to FIG. 2. When the user starts the wireless display operation(s) such as that in any of the wireless display control schemes illustrated in FIGS. 8-18, respectively, as the display resolution of the mobile device 100M is typically different from that of the display device 10, the display contents of the mobile device 100M can be different from that of the display device 10. In practice, the touch event or any other type of action may bring different influence to respective screen contents on the mobile device 100M and the display device 10. For example, under control of the program code 110C mentioned above, the display device 10 may display the program (more particularly, the TV program) and the mobile device 100M may display the associated information (more particularly, the auxiliary information) such as that shown in FIG. 19 and further provide the user with an interactive information access function such as that shown in FIG. 20. In this example, the aforementioned program such as the TV program can be a sports program, and the associated information may comprise some statistical information regarding the players in the sports program, where the user may select or access one or more portions of the statistical information for being displayed, with the aid of the interactive information access function.

Regarding the associated connection procedure, for example, the mobile device 100M may have a second display buffer that differs from the original display buffer utilized for temporarily storing the display contents of the display device 10, and utilize the second display buffer to temporarily store the display contents of the associated information such as the auxiliary information. For example, the second display buffer mentioned above can be the second display memory that differs from the original display memory utilized for temporarily storing the display contents of the display device 10. In another example, the second display buffer mentioned above can be the second display memory region that differs from the original display memory region utilized for temporarily storing the display contents of the display device 10, where the second display memory region and the original display memory region may be within the same memory.

While starting the multiple-screen function, the mobile device 100M may restructure all of the actions on the display module (more particularly, the touch screen) of the mobile device 100M to the same or different resolution on the second display buffer. Although, as mentioned, the mobile device 100M may utilize the second display buffer to temporarily store the display contents of the associated information such as the auxiliary information, this is for illustrative purposes only, and is not meant to be a limitation. When needed, the second display buffer can be utilized for buffering data, to constantly display on the display device 10 with the aid of the wireless display control architecture, which may comprise the control apparatus of the wireless display control agent device 50 (e.g. the control circuit therein) and/or the control apparatus of the mobile device 100M (e.g. the apparatus 100, and more particularly, the processing circuit 110). Under control of the wireless display control architecture, when the user triggers an action on the application to enable the multiple-screen function, different screen contents can be displayed on the mobile device 100M and the display device 10, respectively.

Regarding using the multiple-screen function with the aid of the wireless display control architecture, while the user uses the wireless display control architecture to send the program (e.g. a video program such as the sports program) or a sports game to the display device 10, the streaming content delivers metadata as well. The mobile device 100M may decode the metadata and show the decoded result of the metadata on the display module (more particularly, the touch screen) of the mobile device 100M. As a result, the display device 10 may continue displaying the program (e.g. the video program such as the sports program) when needed, and the user may utilize the mobile device 100M to review the auxiliary information such as the associated personal records year by year. The user can also use any way to obtain the desired information, where the desired information may contain, but not limited to, the delivered metadata.

According to an example, the mobile device 100M may have multiple display buffers (e.g. the aforementioned original display buffer and the aforementioned second display buffer) in dual screen applications, for buffering respective display contents (more particularly, different display contents) of different screens such as the screen of the mobile device 100M and the screen of the display device 10, respectively. In practice, for the mirror display operation, there may be a mirror module in charge of mirroring and DLNA streaming operations, where the mirror module may be implemented with the aforementioned program code 110C. This is for illustrative purposes only, and is not meant to be a limitation. In another example, the mobile device 100M may perform an extended screen operation (rather than the mirror display operation), to achieve a different scenario to display on the display device 10.

By default, the system of the mobile device 100M (e.g. the Android system) may have a display processing module, which owns (or is capable of controlling) the display buffers to display. The mirror module mentioned above may just transit the display contents in one of the display buffers to the wireless display control agent device 50 to display on the display device 10 when performing mirroring. For performing the extended screen operation, the processing circuit 110 (more particularly, the processing circuit 110 executing the program code 110C mentioned above) may add a second display buffer such as that mentioned above for being utilized by the display processing module. The AP side (e.g. the mobile device 100M) can initialize and setup the display contents in the second display buffer for the display device 10 and arrange/rearrange the display buffer layout on the mobile device 100M for the main buffer thereof via framework application programming interfaces (APIs). As a result, the AP side (e.g. the mobile device 100M) can control the display contents to be displayed by the display device 10 properly (e.g., without being limited by the resolution of the mobile device 100M during mirroring), where the display contents respectively displayed by the display device 10 and the mobile device 100M can be different. Additionally, the entry point can be the specific three-finger gesture mentioned above, or can be a virtual button such as any on-screen button/indicator. Based on the wireless display control scheme mentioned above, the user can easily trigger the automatic wireless configuration mentioned above with the aforementioned specific operating gesture (e.g. by merely using the specific three-finger gesture, or by merely pressing a button of the mobile device 100M, or by merely touching a virtual button on a touch screen of the mobile device 100M), and then the apparatus 100 (more particularly, the mobile device 100M) executing the program code 110C can automatically establish the wireless connection mentioned above, where one or more of the mirror display operation, the extended screen operation, and the DLNA streaming operations can be performed.

In some examples, the mode for performing the mirror display operation can be referred to as the mirror mode, while the mode for performing the extended screen operation can be referred to as the DLNA mode.

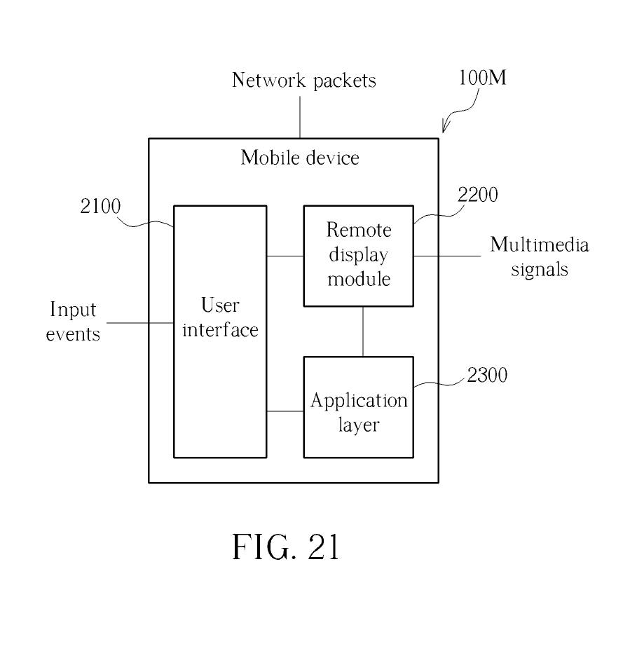

FIG. 21 illustrates some implementation details of the mobile device 100M shown in FIG. 2 according to an example, where the mobile device 100M may comprise a user interface module 2100 (labeled “User interface”, for brevity), a remote display module 2200, and an application layer 2300. In practice, at least one portion (e.g. a portion or all) of the user interface module 2100, the remote display module 2200, and the application layer 2300 can be implemented with the aforementioned program code 110C.

According to this example, the user interface is configured to receive input events (e.g. touch actions) and broadcast the input events to the remote display module 2200 or the application layer 2300. The remote display module 2200 is configured to control the network communication and the multimedia contents to be remotely displayed on the display device 10 (which can be a TV in this example, such as the multifunctional TV or the digital TV disclosed above). For example, the remote display module 2200 may receive information from the Internet (more particularly, receive network packets) through a wireless access point or a cellular network. The remote display module 2200 may further transmit multimedia signals (e.g. from the Internet or from the application layer 2300) to a remote digital media receiver (DMR) connected to a TV (e.g. the wireless display control agent device 50 electrically connected to the display device 10), so that the multimedia signals retrieved from the Internet or stored in the mobile device 100M can be remotely displayed on the TV. The application layer 2300 is configured to execute application programs for various functions of the mobile device 100M.

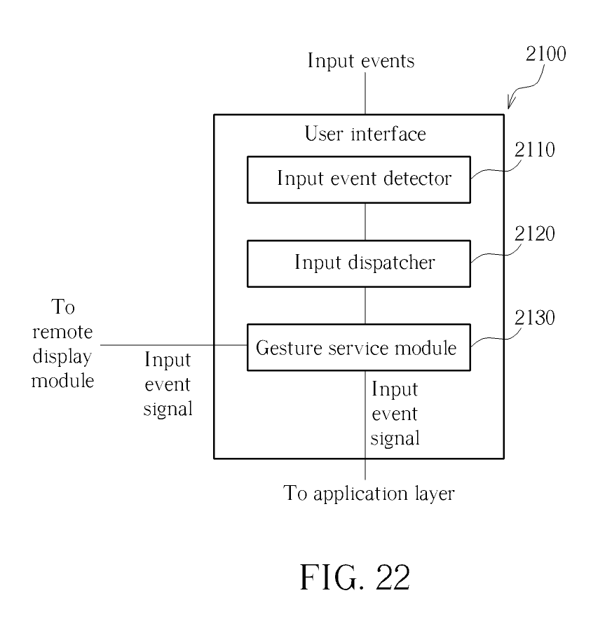

FIG. 22 illustrates a schematic diagram of a user interface module for a touch event in the mobile device shown in FIG. 21, such as the user interface module 2100 shown in FIG. 21, according to an example. As illustrated in FIG. 22, the user interface 2100 may comprise an input event detector 2110, an input dispatcher 2120, and a gesture service module 2130. When the user slides his/her fingertip(s) on the touch-sensitive screen of the mobile device, the input event detector 2110 may generate an input event signal corresponding to the input event (e.g. a touch action or gesture) and transmit the input event signal to the input dispatcher 2120. Then, the input dispatcher 2120 may transmit the received input event signal to the gesture service module 2130.

The gesture service module 2130 may determine whether the input event signal indicates a three-finger touch action. If the input event signal indicates a three-finger touch action, the gesture service module 2130 may broadcast the input event signal to the remote display module 2200 and the application layer may not receive the input event signal. Otherwise, the gesture service module 2130 may broadcast the input event signal to the application layer 2300. Specifically, the gesture service module 2130 may act as a gesture interceptor only when the input event signal is detected as a three-finger touch action. Then, the input event signal can be further used to control the remote display module 2200. For example, if the user slides his/her fingertips on the screen of the mobile device 100M for more than 2 cm, the gesture service module 2130 may detect this action as a specific three-finger gesture with a direction. The remote display module 2200 may receive the detected specific three-finger gesture, and start to search for whether any wireless display control agent device (e.g. the wireless display control agent device 50) is available in the local network (e.g. Wifi local network). If there is at least one wireless display control agent device (e.g. the wireless display control agent device 50) in the local network, the remote display module 2200 may add the currently available wireless display control agent devices (e.g. multiple copies of the wireless display control agent device 50) to the DMR list (i.e. a list to record previously used and currently available wireless display control agent devices), and determine whether the most recently used wireless display control agent device (e.g. the wireless display control agent device 50) is available in the DMR list. If so, the remote display module 2200 may select the most recently used wireless display control agent device (e.g. the wireless display control agent device 50). Otherwise, a currently available wireless display control agent device (e.g. the wireless display control agent device 50) can be selected from the DMR list. Then, the remote display module may start to initialize the mirror process (i,e, the process for performing the mirror display operation) for transmitting the multimedia contents to be displayed on the display device 10 to the selected wireless display control agent device (e.g. the wireless display control agent device 50). If there is no wireless display control agent device available in the local network, the remote display module 2200 may send a notification message to inform the user of connection failure.

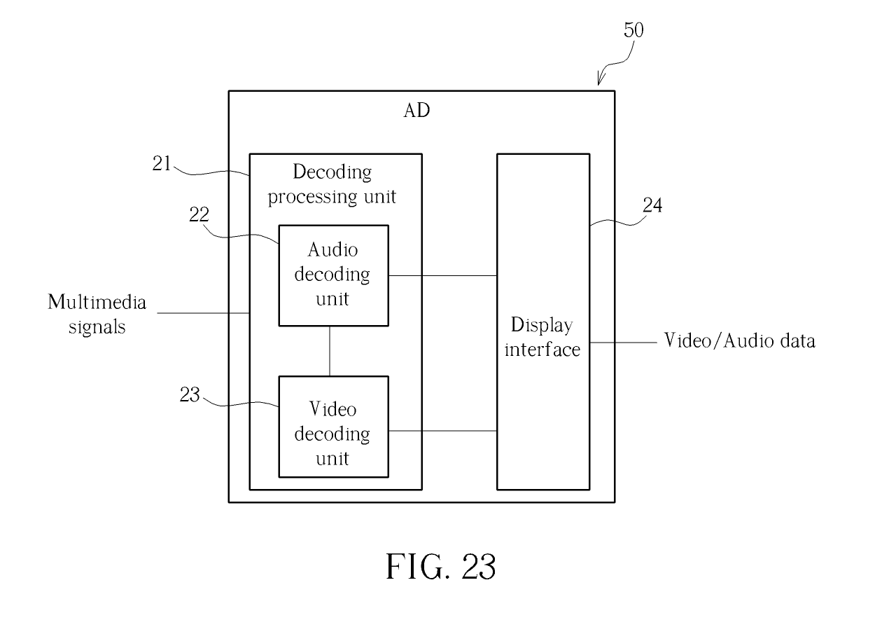

FIG. 23 illustrates a schematic diagram of the wireless display control agent device 50 shown in FIG. 2 according to an example. The wireless display control agent device 50 may comprise a decoding processing unit 21, and a display interface 24, where the decoding processing unit 21 may comprise an audio decoding unit 22 and a video decoding unit 23. In practice, at least one portion (e.g. a portion or all) of the decoding processing unit 21 (comprising the audio decoding unit 22 and the video decoding unit 23) and the display interface 24 can be implemented with at least one processor. This is for illustrative purposes only, and is not meant to be a limitation. In some examples, the audio decoding unit 22 and the video decoding unit 23 can be implemented by hardware or software. In some examples, the display interface 24 may comprise interfacing circuits for the aforementioned connection port (e.g. the HDMI port, the USB port, etc.), or comprise interfacing circuits for one or more display port interfaces.

In the example shown in FIG. 23, the audio decoding unit 22 is configured to decode the encoded audio data from the mobile device 100M. The video decoding unit 23 is configured to decode the encoded video data from the mobile device 100M. Subsequently, the decoded audio/video data can be displayed on the display device 10 through the display interface 24.

In another example, the remote display module 2200 may keep detecting the specific three-finger gesture broadcasted from the gesture service module 2130. Upon detecting the specific three-finger gesture indicating sliding up, the remote display module 2200 may initialize the mirror process if a wireless display control agent device such as the wireless display control agent device 50 is available (e.g. the power is turned on) around the remote display module 2200. Then, the remote display module 2200 may start the mirror process by broadcasting the multimedia signals (e.g. video data and/or audio data) to the wireless display control agent device 50. It should be noted that the video data and/or audio data are encoded by the remote display module 2200 before transmission. The wireless display control agent device 50 may decode the encoded video/audio data simultaneously, thereby achieving real time multimedia content mirroring on the display device 10 (or a speaker) connected to the wireless display control agent device 50.

Generally, there are multiple methods for outputting the multimedia signals, such as illustrating photos in a gallery or an album, displaying videos, and playing music. The remote display module 2200 may present the multimedia content appropriately depending on user needs. For example, when the user wants to view the photos stored in the mobile device 100M on a display device connected to the wireless display control agent device 50, such as the display device 10, the remote display module 2200 may start to broadcast the photos to the display device 10 through the wireless display control agent device 50.

It should be noted that there are multiple methods for viewing photos or videos. One method is to totally duplicate the screen displayed on the mobile device 100M to the display device 10 (e.g. the mirror mode). Another method is to broadcast only the selected photo in the album or the video to the display device 10 through the DLNA protocol (e.g. the DLNA mode). The remote display module 2200 may select a better method to present the multimedia content according to user needs. For example, when the user wants to view photos in an album of the mobile device 100M and initializes the mirror process by using the specific three-finger gesture (e.g. sliding up), the remote display module 2200 may mirror the screen displayed on the mobile device 100M to the display device 10 in the beginning After the user selects one photo to be displayed from the album, the remote display module 2200 may switch to the DLNA mode, so that only the selected photo (without the user interface) will be displayed on the display device 10. It should be noted that the mirror processing of some examples may include the processing of the mirror mode and the processing of the DLNA mode.

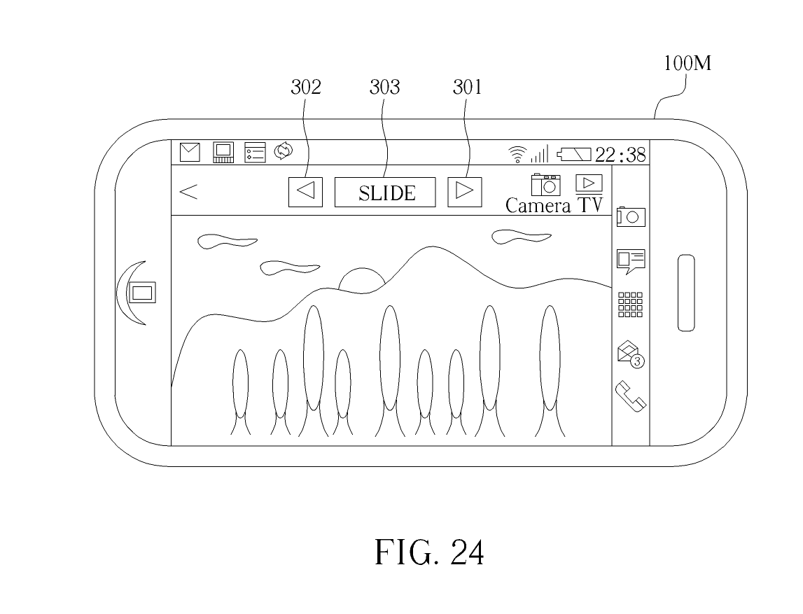

Then, the user may use his/her fingertips to slide left or right on the screen of the mobile device 100M to view the previous or next photo in the album on the display device 10 in the DLNA mode. Alternatively, the user may press the control buttons displayed on the mobile device 100M to view the photos in the album in different ways. For example, as illustrated in FIG. 24, the user may press (or touch) the buttons 301 and 302 to view the next/previous photo in the album, respectively. The user may also press (or touch) the button 303 to view the photos in the album in a slide show.

In yet another example, the user may turn off the mirror process by another specific three-finger gesture (e.g. sliding down on the screen of the mobile device 100M). Specifically, the remote display module 2200 may keep detecting the specific three-finger gesture broadcasted by the gesture service module 2130. If the DNLA mode is used under the mirror processing, the remote display module 2200 may stop the DLNA connection between the mobile device 100M and the wireless display control agent device 50 immediately and then turn off the mirror processing upon detecting the specific three-finger gesture indicating sliding down. If there is only the mirror mode executed by the remote display module 2200, the specific three-finger gesture indicating sliding down may turn off the mirror mode directly. Furthermore, the remote display module 2200 may send a notification message to inform the user of the termination of the connection.

In some examples, the user may utilize various kinds of three-finger gestures to trigger different types of processing of the mirror mode and different types of processing of the DLNA mode, respectively. For example, one of these three-finger gestures can be utilized for triggering an operation of illustrating photos in a gallery or an album, and another of these three-finger gestures can be utilized for triggering an operation of displaying videos, while another of these three-finger gestures can be utilized for triggering an operation of playing music.

According to an aspect, the aforementioned computer program product can be composed of several code segments. In addition, after these code segments are loaded into the apparatus 100 (more particularly, the processing circuit 110) and are executed, the steps and features of the method shown in FIG. 3 can be implemented.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing wireless display control, the method being applied to an electronic device, the method comprising the steps of:
detecting whether a wireless display control agent device corresponding to the electronic device exists, wherein the wireless display control agent device is utilized as an agent for the electronic device to perform wireless display control on a display device in a situation where the display device is electrically connected to the wireless display control agent device; and
when it is detected that the wireless display control agent device exists, providing a user with a user interface, allowing the user to utilize a specific operating gesture to start an automatic wireless configuration of the electronic device without performing any manual wireless configuration of the electronic device, wherein based upon the automatic wireless configuration, a wireless connection between the electronic device and the wireless display control agent device is automatically established.

2. The method of claim 1, wherein the step of detecting whether the wireless display control agent device corresponding to the electronic device exists further comprises:
automatically scanning for the wireless display control agent device, wherein the wireless display control agent device is equipped with an access point (AP) function that is activated by default for a purpose of being scanned by the electronic device.

3. The method of claim 1, wherein the step of providing the user with the user interface allowing the user to utilize the specific operating gesture to start the automatic wireless configuration of the electronic device without performing any manual wireless configuration of the electronic device further comprises:
when it is detected that the wireless display control agent device exists, providing the user with the user interface, allowing the user to merely utilize the specific operating gesture to start the automatic wireless configuration of the electronic device without performing any manual wireless configuration of the electronic device.

4. The method of claim 1, further comprising:
during the automatic wireless configuration, selecting one of a plurality of predetermined connection topologies of a plurality of wireless devices according to a predetermined priority, with the plurality of wireless devices comprising the electronic device and the wireless display control agent device.

5. The method of claim 4, further comprising:
dynamically switching between the predetermined connection topologies when needed.

6. The method of claim 4, wherein the predetermined priority corresponds to at least one of power and throughput associated with the predetermined connection topologies.

7. The method of claim 1, wherein the step of providing the user with the user interface allowing the user to utilize the specific operating gesture to start the automatic wireless configuration of the electronic device without performing any manual wireless configuration of the electronic device further comprises:
when it is detected that the wireless display control agent device exists, controlling the electronic device to generate a notification indicating that the wireless display control agent device is found.

8. The method of claim 7, wherein the notification is displayed by a display module of the electronic device.

9. The method of claim 1, further comprising:
controlling the electronic device to output a command to the wireless display control agent device through the wireless connection, in order to turn on or turn off the display device by utilizing the wireless display control agent device.

10. The method of claim 1, further comprising:
controlling a display module of the electronic device and the display device to display different screen contents, respectively, wherein the screen content of the display device is received through the wireless display control agent device.

11. The method of claim 1, wherein the specific operating gesture is a specific three-finger gesture.

12. An apparatus for performing wireless display control, the apparatus comprising at least one portion of an electronic device, the apparatus comprising:
a wireless control circuit arranged to perform wireless communication control for the electronic device; and
a processing circuit arranged to detect, by utilizing the wireless control circuit, whether a wireless display control agent device corresponding to the electronic device exists, with the wireless display control agent device being utilized as an agent for the electronic device to perform wireless display control on a display device in a situation where the display device is electrically connected to the wireless display control agent device, wherein when it is detected that the wireless display control agent device exists, the processing circuit provides a user with a user interface, allowing the user to utilize a specific operating gesture to start an automatic wireless configuration of the electronic device without performing any manual wireless configuration of the electronic device, wherein based upon the automatic wireless configuration, a wireless connection between the electronic device and the wireless display control agent device is automatically established.

13. The apparatus of claim 12, wherein the processing circuit automatically scans for the wireless display control agent device, wherein the wireless display control agent device is equipped with an access point (AP) function that is activated by default for a purpose of being scanned by the electronic device.

14. The apparatus of claim 12, wherein when it is detected that the wireless display control agent device exists, the processing circuit provides the user with the user interface, allowing the user to merely utilize the specific operating gesture to start the automatic wireless configuration of the electronic device without performing any manual wireless configuration of the electronic device.

15. The apparatus of claim 12, wherein during the automatic wireless configuration, the processing circuit selects one of a plurality of predetermined connection topologies of a plurality of wireless devices according to a predetermined priority, with the plurality of wireless devices comprising the electronic device and the wireless display control agent device.

16. The apparatus of claim 15, wherein the processing circuit dynamically switches between the predetermined connection topologies when needed.

17. The apparatus of claim 15, wherein the predetermined priority corresponds to at least one of power and throughput associated with the predetermined connection topologies.

18. The apparatus of claim 12, wherein when it is detected that the wireless display control agent device exists, the processing circuit controls a display module of the electronic device to display a notification indicating that the wireless display control agent device is found.

19. The apparatus of claim 12, wherein the processing circuit controls the electronic device to output a command to the wireless display control agent device through the wireless connection, in order to turn on or turn off the display device by utilizing the wireless display control agent device.

20. The apparatus of claim 12, wherein the processing circuit controls a display module of the electronic device and the display device to display different screen contents, respectively, wherein the screen content of the display device is received through the wireless display control agent device.

21. The apparatus of claim 12, wherein the specific operating gesture is a specific three-finger gesture.

22. A method for performing wireless display control, the method being applied to an electronic device, the method comprising the steps of:
detecting whether a wireless display control agent device corresponding to the electronic device exists, wherein the wireless display control agent device is utilized as an agent for the electronic device to perform wireless display control on a display device in a situation where the display device is electrically connected to the wireless display control agent device;
when it is detected that the wireless display control agent device exists, starting an automatic wireless configuration of the electronic device without performing any manual wireless configuration of the electronic device, wherein based upon the automatic wireless configuration, a wireless connection between the electronic device and the wireless display control agent device is automatically established; and
providing a user with a user interface, allowing the user to utilize a specific operating gesture to display a portion or all of screen content of the electronic device on the display device via the wireless display control agent device.
